(19) United States
(12) Patent Application Publication
(10) Pub. No.: US 2014/0302199 A1
(43) Pub. Date: Oct. 9, 2014

(54) TOFU MANUFACTURING PROCESS

(71) Applicants: Pulmuone Holdings Co., Ltd., Chungbuk (KR); Pulmuone Foods USA, Inc., Fullerton, CA (US)

(72) Inventors: Chang Soo Kang, Incheon (KR); Guan Ho Byun, Cypress, CA (US); Ik Hyun Yeo, Seoul (KR); Young Chul Kang, La Palma, CA (US); In Hwan Park, Gyeongsangnam-do (KR); Seong Jun Kim, Fullerton, CA (US); Seung Woo Nam, Seoul (KR)

(73) Assignees: Pulmuone Holdings Co., Ltd., Chungbuk (KR); Pulmuone Foods USA, Inc., Fullerton, CA (US)

(21) Appl. No.: 14/246,743

(22) Filed: Apr. 7, 2014

Related U.S. Application Data
(60) Provisional application No. 61/830,339, filed on Jun. 3, 2013.

(30) Foreign Application Priority Data
Apr. 8, 2013 (KR) 10-2013-0038085

(51) Int. Cl. A23L 1/20

(52) U.S. Cl. CPC A23L 1/2006; A23L 1/2008
USPC 426/46; 426/634

(57) ABSTRACT

An improved tofu having reduced beany flavor, whiter color, more elasticity, reduced porosity and more consistent characteristics than traditional tofu.

### RELATED APPLICATIONS

This application claims priority to Korean Patent Application No. 10-2013-0038085, filed Apr. 8, 2013, and United States Patent Application Ser. No. 61/830,339, filed Jun. 3, 2013, both of which are incorporated herein in their entirety by this reference.

### FIELD OF THE INVENTION

The present invention relates generally to a process for manufacturing tofu and, more specifically, to a process for manufacturing tofu wherein a higher level of concentration of solids is achieved, an enzyme is used in the coagulation step and an emulsion of a coagulating agent and oil is used, resulting in an improved tofu.

### BACKGROUND OF THE INVENTION

Discovered over 2000 years ago by the Chinese, tofu is sometimes called “the cheese of Asia,” because of its physical resemblance to a block of farmer's cheese. Tofu is a highly nutritious, protein-rich food that is made from the curds of soybean milk. Off-white in color, it is usually sold in rectangular blocks. Tofu is a staple in the cuisines of many Asian countries, and is a product by itself or a starting material for a variety of related products, including fermented, salted, smoked, dried and fried derivatives. Tofu is its Japanese name, while in China it is known as doufu.

Tofu has been made in the United States since the beginning of the 20th century, at least initially as an ethnic food. Its consumption in the West has increased rapidly since the 1970s, mainly as a vegetarian alternative to meat and cheese or as a novel food by itself. The development of alternative uses of tofu, such as tofu-based ice-cream, burgers and sauces, has been a significant factor in the recent growth of tofu production in the West. Today, a variety of types and brands are available in most supermarkets.

Basic regular tofu is a white, essentially bland, soft product, closely resembling pressed white milk curd. Its production starts with a soybean soaking process to prepare the soybeans for extraction of the soy protein. Whole, dry soybeans are saturated with water at ambient temperature for 10 to 14 hours; alternatively, soybean flakes or “grits” are sometimes used.

Soaked beans or flakes are ground to the desired particulate size using a grinder, micro-cutter, hammer mill or similar device. This may occur with or without water. Ground soybean slurry is subsequently cooked, typically with direct or indirect heat or steam, up to 100° C. to 110° C. for 3 to 10 minutes. During the cooking process, soy protein is denatured and some of the volatile beany flavors are removed. The resultant soy slurry goes through an optional filtration process to remove all or part of the soy pulp or fiber, traditionally referred to as okara. Alternatively, the filtration process may occur before cooking. The resulting product, now referred to as soymilk, is then coagulated to form curds and whey. Whey is then removed before the curds are pressed or while the curds are pressed. The finished pressed curds may now be referred to as tofu, soybean curd.

The coagulation of soymilk, actually coagulation of protein and oil (in an emulsion) suspended in the soymilk, is the most important step in tofu production. This process is accomplished with the aid of coagulants. Two types of coagulants are used, salts and acids. To cause coagulation, the soymilk temperature is adjusted to 70° C. to 90° C., and then a coagulant, which typically comprises gypsum powder, magnesium salts, nigari (primarily magnesium chloride), glucono-delta-lactone (GDL) or some combination, is added. Stirring induces a reaction between the coagulants and soymilk. When large white curds can be seen floating in a clear yellow liquid, the whey, the soymilk is completely curded and ready to be filtered into a suitable mould. To form a block of tofu, the curds are traditionally pressed in a cloth-lined container for several minutes to reduce the water content by approximately 50 to 60 percent, although more modern techniques produce tofu using a continuous stream of soymilk at one end and tofu sliced or cut into blocks at the other end with the tofu being pressed to remove water near the end.

A different method is used for the industrial production of “silk tofu”, a softer and silk-like smooth texture or more fragile type of bean curd. Here the production process resembles that of yogurt rather than cheese manufacturing. Soymilk with a high content of solids (11-13% instead of 9-10% in regular tofu) is obtained from the cooking process and then cooled to 5-15° C. Glucono-delta-lactone (GDL) is added as a coagulant and the mixture is filled into the final retail containers. After sealing, the filled containers are heated in a water bath at 80 to 90° C. for 30 to 60 minutes. At this temperature, GDL is transformed to gluconic acid, which causes the protein to coagulate as a homogeneous gel, with no whey separation.

In the West, there exist certain consumer issues with traditionally manufactured tofu, including a general dislike of beaniness, yellow color, and texture. Accordingly, there is a need for improved tofu products which have reduced beany flavor, a whiter color and improved texture.

### SUMMARY OF THE INVENTION

The invention consists of an improved method of producing tofu and the improved tofu produced by the method. In preferred embodiments, whole soybeans are submitted to the traditional soaking process and then optionally passed through a dehulling machine. As opposed to dehulling prior to soaking, there is a reduced loss of soybeans and an improved removal of the hull which results in a decrease in the beany flavor imparted to the tofu and a smoother mouth feel of the tofu. The hulled or dehulled soybeans are milled with water and the slurry cooked. Soymilk is extracted by removal of okara. Additional water is then removed to increase the concentration of solids in the soymilk without the use of additional heat, preferably by the use of reverse osmosis or vacuum evaporation and optionally assisted by nanofiltration. By avoiding the use of heat, issues relating to changes in viscosity and degradation of organoleptic qualities do not arise. The concentration of solids in the soymilk can be increased up to 20% with reverse osmosis or 22% with vacuum evaporation, much higher than the 13% manageable in conventional tofu soymilk processes. The coagulation step has also been improved. A conventional coagulant, such as magnesium chloride or nigari, is preferably combined with one or more natural oils using high shear mixing to create an emulsion. An enzyme that catalyzes the cross-linkage of amino acids in the soymilk is added to the coagulant/oil emulsion and the mixture is added to the high solids concentration soymilk. The resultant tofu is non-porous and silky in appearance and has a firm texture; it can be utilized in a broad range of applications, including as regular tofu or as a “silk tofu”.

An object of the present invention is to provide an improved method of producing tofu that includes the steps of producing a slurry of ground or comminuted soybeans, cooking the slurry, extracting insolubles from the slurry to produce soymilk with solids at the level of between about 10 to about 13%, removing additional water from the soymilk without the use of heat to increase the concentration of solids to at least 14%, adding a coagulant mixture to the concentrated soymilk while mixing at a temperature of about 60 to 75 ° C., and coagulating the soymilk at an elevated temperature for 30 minutes or longer.

Another object of the present invention is to provide an improved method of producing tofu wherein an enzyme that catalyzes amino acid cross-linkage is added to the concentrated soymilk before or during the coagulation step.

A further object of the present invention is to provide an improved method of producing tofu wherein the coagulant mixture is a tofu coagulant combined with one or more natural oils using high shear mixing to produce an emulsion, dispersion or suspension of the tofu coagulant and the one or more natural oils. Yet another object of the present invention is to provide an improved tofu having reduced beany flavor, whiter color, more elasticity, reduced porosity or more consistent characteristics than traditional tofu.

Yet a further object of the present invention is to provide an improved method of producing tofu wherein the whole soybeans are soaked in water to loosen the hull and the hull is removed prior to producing the slurry.

Still another object of the present invention is to provide an improved method of producing tofu by removing additional water from the soymilk without the use of heat to increase the concentration of solids to between about 14 and 22%.

Yet another object of the present invention is to provide an improved method of producing tofu wherein the concentrated soymilk is homogenized prior to addition of the coagulant.

These and other objects of the present invention will become known to those of skill in the art upon a review of this specification, the associated drawings and the appended claims.

### BRIEF DESCRIPTION OF THE DRAWINGS

FIG. 1 is a chart of the decrease in viscosity and the increase in pH of soymilk produced from dehulled soybeans.

FIG. 2 is a chart of the brighter color of soymilk produced from dehulled soybeans.

FIG. 3 is a flow chart of a preferred process of the present invention employing nanofiltration.

FIG. 4 is a chart of the effect of nanofiltration on tofu texture.

FIG. 5 is a flow chart of a preferred process of the present invention employing vacuum evaporation.

FIG. 6 is a chart showing the effect of homogenization on tofu texture.

FIG. 7 is a chart showing the results of a sensory panel comparing nine different organoleptic properties of tofu made by the methods of the present invention to commercially available firm-style tofu.

### DETAILED DESCRIPTION OF PREFERRED EMBODIMENTS

A “high-shear mixer” is one which disperses an oil phase into an aqueous phase or an aqueous phase into an oil phase producing an emulsion, suspension or dispersion of the two phases.

The term “soybeans” means beans of the legume species Glycine max as well as the processed materials produced from the beans, such as soybean flakes and soybean grits, used in the art in or suitable for the production of tofu. In the following Examples, commercial high protein, clear hilum variety soybeans were purchased from a producer. Texture of tofu produced under the various methods was measured using a texture analyzer (RHEO Meter, SUN Science Co., Ltd., Japan) with the units of Max.g for firmness and Pa for elasticity. The viscosity and pH of soymilk made under the various methods was measured with a viscometer (Brookfield Model DV-II+, MA, US) and pH meter (TitroLine easy 24-9, Germany), respectively. The color and lightness of soymilk and tofu produced under the various methods was measured using a spectrophotometer (Konica Minotla CM-3500d, Japan).

In the recited comparisons, conventional tofu was made following conventional tofu making processes wherein a mixture of glucono-delta-lactone (GDL), calcium sulfate and nigari was used to coagulate hot 11% solids soymilk and compared against tofu produced using the methods of the present invention as recited in the Examples.

### EXAMPLE 1

### Dehulling

While the dehulling process is optional, the beany flavor of existing tofu has prevented tofu from achieving a highly acceptable organoleptic quality in Western cultures. The primary source of beany flavor is the soybean hull. Saponins, isoflavones, and phytic acid are considered major contributors to the unpleasant beany flavor in tofu. Phytic acid is mainly found in the hull and saponins are found in both the hypocotyls and the hull. Using soybeans with removal of the hull, tofu with significantly less unpleasant flavor can be made. Also, as the soybean hull contains a lot of fiber, removal of soybean hull can contribute to a smoother mouth feel of the tofu. The typical dehulling method involves splitting dry soybeans. This, however, results in damage to and loss of usable parts of the soybeans and therefore higher costs. The process of the present invention preferably dehulls the soybeans after soaking, thereby greatly reducing damage and loss issues.

Conventionally, the dehulling process begins with air cleaning to remove dirt, followed by short duration steaming to induce the hull to slide off the bean when the steamed whole bean is split into half, quarter or smaller pieces. The beans are then scrubbed to remove the hulls, which are blown away. This process results in some loss of dehulled soybeans and requires careful management of the soaking process as to temperature, time, and equipment.

The present invention accomplishes dehulling by passing traditionally soaked soybeans through a dehulling device that has rotating rubber rollers. Abrasion between the rollers and the soybeans removes the swollen hull off the soaked soybean without losing soybeans. The hulls or husks are delivered to a collection tank while the dehulled soybeans are delivered to a separate collection vat before transfer to a subsequent grinding process. As the dehulling process is applied to soaked soybeans, it is not necessary to modify existing soaking processes or other process parameters. Dehulling post soaking yields 85% of the soybean verses only 70-80% when removing hulls prior to soaking, and there is less creation of split beans prior to grinding to a slurry.

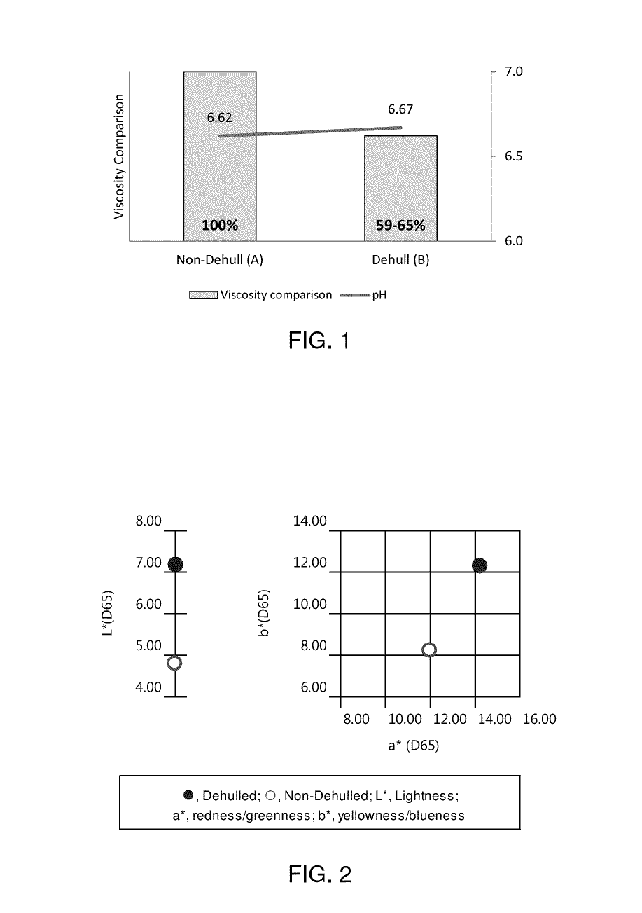

Dehulling reduces the viscosity and increases the pH of the soymilk produced from the dehulled soybeans, both of which are desirable in tofu production. FIG. 1 presents averages of data taken of dehulled soybeans vs. hulled soybeans showing a reduction in viscosity of between 35 and 41% and an increase in pH from 6.62 to 6.67.

Dehulling also improves the color of the soymilk produced from the dehulled soybeans, resulting in a brighter color. FIG. 2 shows an improvement in lightness (L) and a shift toward more redness/greenness (a) and more yellowness/blueness (b). The color difference, ΔE*ab=5.04, is significant (significant difference when ΔE*ab>3.0).

### EXAMPLE 2

### Concentration of Solids

Traditional soymilk extraction processes have limitations as to the level of concentration of solids that can be well managed by the processing equipment and it is difficult to heat higher concentrations without negatively impacting the quality of the final product during the heating/cooking process. The upper limit of traditional processes is about 13% solids. The approach of the present invention provides much higher level of solids concentration, up to as high as 20% to 22%, without causing a quality problem during the cooking process.

Traditionally, the concentration of solids in soymilk is determined by the ratio of soaked soybeans to water used in the grinding process. The more water used, the lower the resulting concentration of solids in the soymilk. A higher concentration of solids in the soymilk results in a thicker, nutty flavor in soymilk and tofu, as well as a firmer texture. Typically, tofu soymilk is at a 9-10% solids level for traditional firm tofu and 11-13% solids level for silken tofu. The upper limit on concentration has been about 13% solids in tofu soymilk because of the difficulties in the cooking process and in the filtration process. Over the high limit, soaked soybean ground slurry cannot be pumped through the cooking machine and it becomes difficult or impossible to yield a consistent product in the cooking process. Also, a high concentration of solids in the soymilk results in high viscosity of the soymilk which causes difficulty in filtering and reduces the yield of soymilk and can interfere with curding resulting in tofu with a relatively less firm texture.

Reverse osmosis (“RO”) is a membrane filtration technology that removes many types of large molecules and ions from solutions by applying pressure to the solution when it is on one side of a selective membrane. The result is that the solute is retained on the pressurized side of the membrane and the pure solvent is allowed to pass to the other side. To be “selective”, this membrane should not allow large molecules or ions through the pores, but should allow smaller components of the solution (such as the solvent or water) to pass freely. When RO technology is applied to soymilk, water molecules in the soymilk are filtered out through the membrane. As a result, the remaining soymilk has a higher concentration of solids. In a preferred embodiment of the present invention, a Filmtec BW30-4001G reverse osmosis membrane of Dow Chemical was used.

To utilize the RO process, typical tofu soymilk at a concentration of about 9-11% solids is cooled down to 5-20° C. and then stored in a designated jacketed storage tank prior to using the RO process. The temperature adjusted soymilk is run through the RO system to concentrate the soymilk concentration up to the desired level of about 13 to 17% solids. As no heating is required to concentrate the soymilk, there are no quality integrity change issues in terms of viscosity and organoleptic quality. For conventional tofu, concentrated soymilk, usually between 13 to 17% solids, is maintained at or reheated up to 55 to 75° C. for the coagulation process. Use of 13 to 17% solids soymilk from RO process can create firm style tofu, which is superior in quality to conventional firm tofu. Conventional firm tofu, utilizing 9 to 10% solids tofu soymilk must be broken and pressed in order to achieve the same firmness. The breaking and pressing process causes a porous texture and yield loss in production. The tofu made from RO concentrated soymilk has a smooth, elastic and nonporous texture and there is no yield loss from the pressing process.

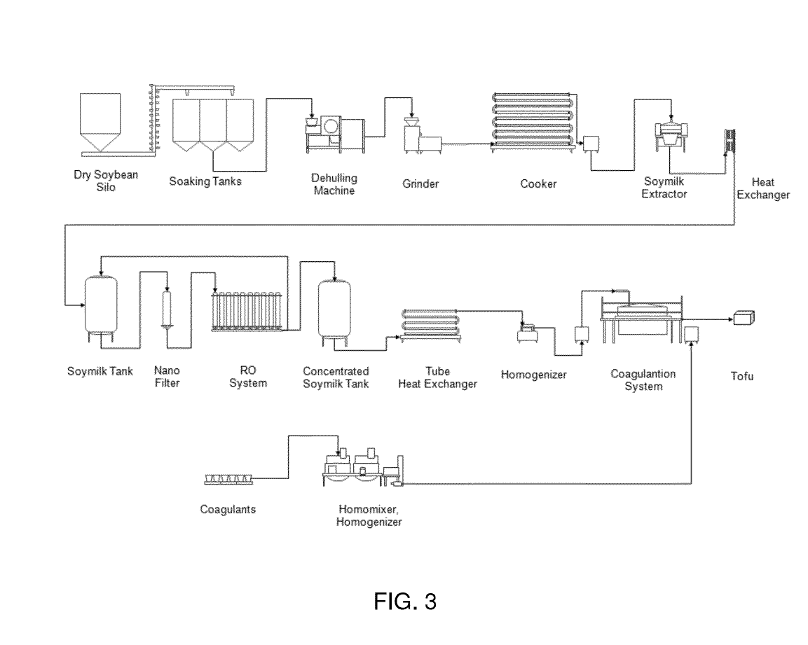

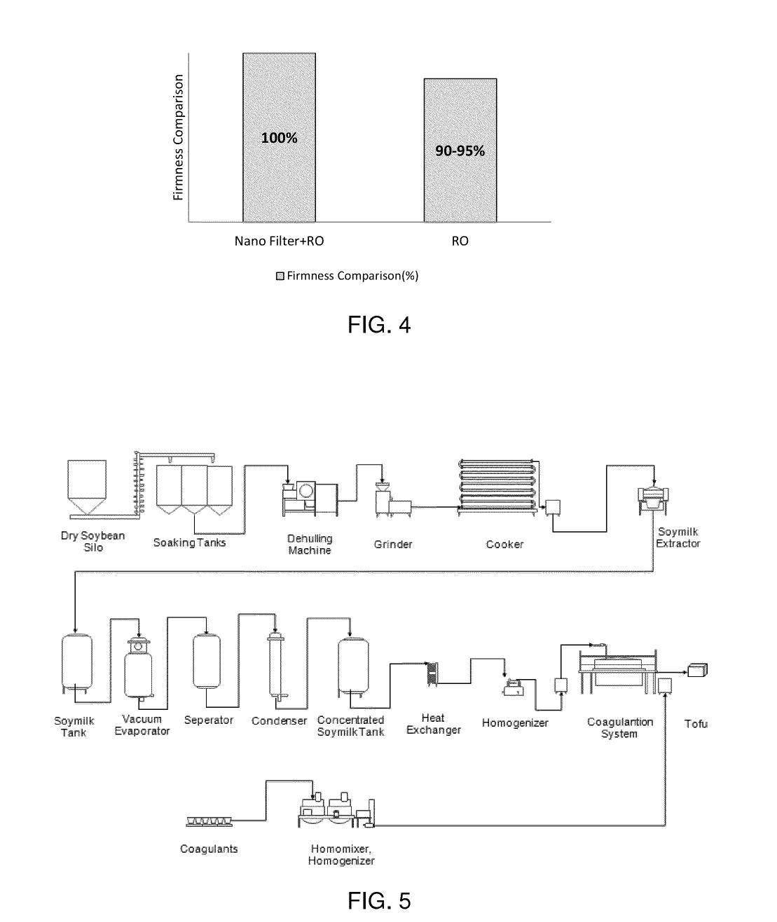

Soymilk can also be concentrated by using nanofiltration. Nanofiltration can be applied either by itself or preferably either before or after the reverse osmosis process of concentration. A nanofiltration system applied prior to reverse osmosis can increase the efficiency of the concentration process. In addition, use of nanofiltration can shorten the time required for concentration of soymilk to the desired level and so can reduce to loss of desired flavors from the soymilk. Also, nanofiltration can selectively remove univalent and divalent sodium ions which can inhibit coagulation thereby improving the reaction between a coagulant and the soy protein during the later coagulation step and can result in firmer tofu. In a preferred embodiment of the present invention, a Filmtec NF245-3838/30FF nanofiltration membrane of Dow Chemical was used. FIG. 3 shows a schematic diagram of a tofu process of the present invention wherein nanofiltration has been used in the process. The process of FIG. 3 was operated with nanofiltration and, as shown in FIG. 4, the resulting tofu had a firmer texture than the comparison tofu produced when the process of FIG. 3 was operated without the nanofiltration unit. Evaporation under vacuum is another way to concentrate soymilk up to 22% solids. The soymilk temperature is adjusted to about 55 to 70° C. and then introduced into a chamber under vacuum (FIG. 5). While running through the vacuum chamber, water in the soymilk is evaporated without causing damage on the soymilk quality. During the evaporation under vacuum process, volatile flavors are removed as well, so the evaporation process can help reduce beany off flavors. Vacuum-concentrated soymilk is coagulated after temperature adjustment to 60-75° C. using a heat exchanger.

### EXAMPLE 3

### Color and Mouth Feel

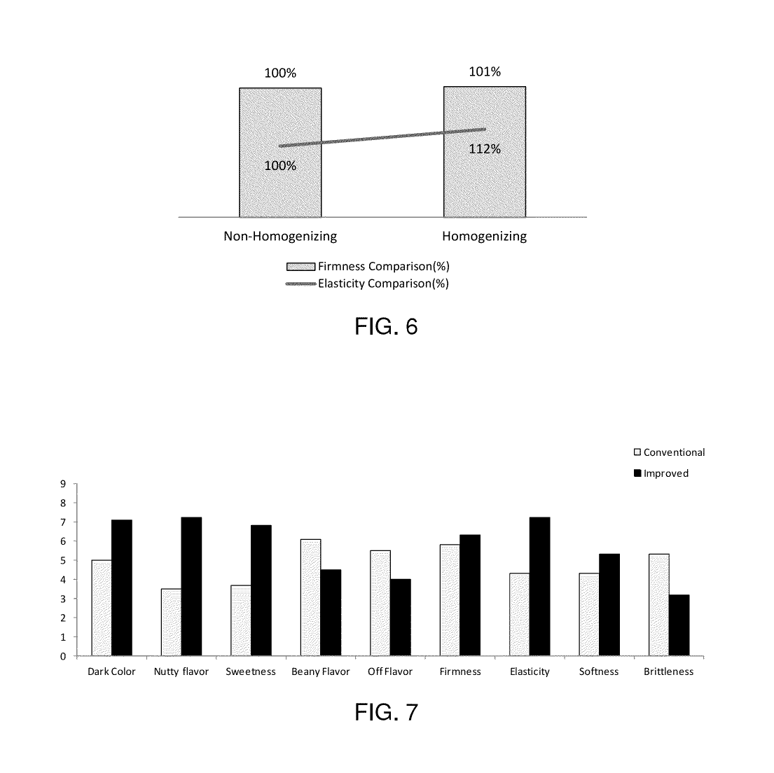

Traditional soymilk processing leaves a brownish-yellow off color and poor mouth feel. In addition to the novel removal of the hull process discussed earlier, the approach of the present invention utilizes homogenization of the soymilk to create a whiter color and smoother mouth-feel. The concentrated soymilk of 13 to 17% solids is heated to about 55-75° C. for homogenization at a pressure of 100 to 300 Bar. Batches of tofu made with homogenization had higher elasticity and hardness than batches made without homogenization. Comparison of batches of tofu with homogenization to the comparison tofu in FIG. 6 shows that elasticity increased by about 12% on average and hardness increased by only about 1% on average. This is a significant and very surprising result in that those skilled in the art would expect a much larger change in hardness given the change in elasticity.

### EXAMPLE 4

### Textural Issues

Traditional tofu often has unpredictable textural properties, porosity, permeability, crumbliness, appearance and handling. Generally, when tofu is coagulated using different types of coagulants such as nigari, magnesium chloride, calcium sulfate (gypsum), calcium chloride, and GDL, the flavor is different. Nigari is well known as a coagulant that creates a nutty, sweet flavor in tofu. Derived from sea salt or sea water, it is composed primarily of magnesium chloride, but in its unrefined form contains many of the other constituents of sea water. Magnesium chloride is refined nigari. However, the reaction of magnesium chloride and soy protein is so rapid that it can be a hindrance to the tofu maker to get the desired smooth and creamy textured tofu product. While temperature control of the soymilk and gentle stirring or agitation of the soymilk during addition of the coagulant solution can help control the reaction velocity, it is difficult to ensure consistency of tofu curding.

In addition to the concentration methods discussed above, the approach of the present invention uses an enzyme during coagulation with a minimum amount of coagulant, either magnesium chloride or nigari, coated with a natural oil using an emulsification process to create a predictably smooth and elastic tofu product.

The enzyme utilized in the present invention is transglutaminase. This enzyme is composed of simple amino acid chains and widely found in living organisms, including beef, pork, poultry, fish, shellfish and vegetables. Commercially available Ajinomoto's Activa® transglutaminase is produced through a microorganism fermentation process. Transglutaminase catalyzes the cross-linkage of side chains of two amino acids, glutamine and lysine, in liquefied proteins, and thus yields ε-(γ-glutamyl)-lysine bond. When this enzyme is applied to soymilk at 60 to 75° C. in the presence of salt or acid coagulants and coagulated for 30 to 40 minutes or longer, the resulting tofu is smooth, soft, and highly elastic and has great water retention capability. In the present invention, nigari is the preferred coagulant for use with transglutaminase.

The present invention preferably uses nigari that has been emulsified in one or more natural oils. In some preferred embodiments, the mixture is about 30-70% aqueous nigari solution, 20-50% safflower oil, and 10-20% macadamia seed oil or almond oil, or 30-70% aqueous nigari solution and 30-70% safflower oil. The nigari solution is emulsified in oils by a homogenizing mixer at the speed of 3000-5000 rpm for 3-10 min at 10 to 30° C. Subsequently, the initial emulsion is stabilized in a secondary high shear mixer at 10000 to 15000 rpm for 1 to 3 seconds, and then cooled down to 10 to 20° C. or less for storage. The transglutaminase is combined with the nigari and oil emulsion to form the mixture used in the coagulation step.

Coagulation of soymilk using the emulsion of nigari and oil is initiated by mixing the natural coagulant in soymilk at 1000-3000 rpm high shear mixing for 1-30 sec at a soymilk temperature of 60 to 75° C. using an in-line mixer or homogenizer mixer. While high shear mixing, the nigari coated by oil is released into the soymilk. By controlling the velocity of nigari release into the soymilk, the coagulation reaction can be controlled as desired.

The process continues as follows. The mixture temperature tofu soymilk and coagulant is maintained in a range of 60 to 75° C. This temperature range is optimal to ensure progression of the enzyme reaction as well as protein coagulation by the nigari. Coagulation occurs for 30 to 40 minutes or longer. After coagulation, the resulting soybean curds have a smooth, soft and elastic texture with certain firmness. Pressing the tofu to remove water is an option; however, the curds need not be broken and pressed to achieve a desired firmness as is the case with conventional tofu.

When soymilk with a high concentration of solids, around 13 to 17% or higher, is coagulated using transglutaminase and oil-coated coagulants, a non-porous, silky in appearance firm texture tofu is created. The texture of this novel tofu is strong enough to handle for multipurpose applications, and its appearance is very smooth, without the pores normally found in traditional firm tofu.

### EXAMPLE 5

### Silk-style Tofu

The improved tofu process can be used for silk-style tofu.

Soymilk obtained from the improved processes after nanofiltration, reverse osmosis or vacuum evaporation, and homogenizing, is adjusted in temperature to 5-15° C. before blending with one of the selected coagulants such as GDL, or a combination of multiple coagulants, preferably using a coagulant emulsion of one of the preferred embodiments of the invention.

When a softer texture is preferred, the 13-17% soymilk concentration is diluted to 10-15% with clean water. Also, when flavored tofu is preferred, liquid or powder types of flavor are added at this step.

Subsequently, when a coagulant and oil emulsion is used as a coagulant, homogenous mixing using in-line mixer at 1000-5000 rpm for 1-50 sec at soymilk coagulant or flavors mixture temperature 5-25° C. is applied in order to induce the reaction between the coagulant and the soy proteins in soymilk. The mixture is then filled into the final containers. In case of using GDL or others as coagulants, they can be mixed with soymilk using an impeller type mixer, an inline static mixer, or other homogenous mixing method before filling into the containers. After sealing, the filled containers are heated in a water bath at 75 to 95° C. for 30 to 90 minutes, and continuously cooled down to 5° C. or less.

The silk-style tofu from the improved process results non-porous and firm or soft and smooth texture.

When flavoring is applied, many of different type of flavors can be combined with the novel texture and desirable tofu.

### Conclusion

When these distinctive processes and technologies are used, the resulting tofu is substantially sweeter (less beany), whiter, more elastic and more consistent than traditional tofu. It can stand alone as a superior product or be combined as a predictable and easily handled ingredient in various food products. A panel of 44 regular tofu consumers were given a sensory test to compare the organoleptic parameters of commercially available firm-style tofu and tofu made under the present invention. The data were subjected to statistical analysis using the T-test of SPSS software (IBM). The results are presented in FIG. 7.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

We claim:

1. An improved method of producing tofu comprising the steps of:
(a) comminuting soybeans to produce a slurry;
(b) cooking the slurry;
(c) extracting okara from the slurry to produce soymilk with solids at the level of 10 to 13%;
(d) removing additional water from the soymilk without the use of additional heat to increase the concentration of solids to at least 14%;
(e) adding a coagulant mixture to the concentrated soymilk while mixing at a temperature of about 60 to 75° C.; and
(f) coagulating the soymilk at an elevated temperature for 30 minutes or longer.

2. The improved method of claim 1, further comprising an enzyme that catalyzes amino acid cross-linkage added to the concentrated soymilk before or during the coagulation step.

3. The improved method of claim 1, wherein the coagulant mixture comprises a tofu coagulant combined with one or more natural oils using high shear mixing to produce an emulsion or suspension of the tofu coagulant and the one or more natural oils.

4. An improved tofu having reduced beany flavor, whiter color, more elasticity, reduced porosity and more consistent characteristics than traditional tofu, comprising the tofu made by following the method of claim 1.

5. An improved method of producing tofu comprising the steps of:
(a) soaking whole soybeans in water to loosen the hull;
(b) dehulling the soybeans;
(c) comminuting the dehulled soybeans to produce a slurry;
(d) cooking the slurry;
(e) extracting okara from the slurry to produce soymilk with solids at the level of 10 to 13%;
(f) removing additional water from the soymilk without the use of additional heat to increase the concentration of solids up to about 14 to 16%;
(g) homogenizing the concentrated soymilk;
(h) adding an emulsion of a coagulant and an oil to the concentrated soymilk while mixing at a temperature of about 60 to 75° C.; and
(i) coagulating the soymilk at an elevated temperature for 30 minutes or longer.
